(19) United States
(12) Patent Application Publication
(10) Pub. No.: US 2010/0157173 A1
(43) Pub. Date: Jun. 24, 2010

(54) ROTARY DISPLAY PROVIDED WITH IMAGE PICKUP DEVICE

(75) Inventors: TSUNG-I WANG, Tao-Yuan Hsien (TW); CHIN-CHUN WU, Tao-Yuan Hsien (TW); CHIA-LIANG YANG, Tao-Yuan Hsien (TW); HSU-TSUNG SHIN, Tao-Yuan Hsien (TW)

Correspondence Address: Yen Jung Sung, 21-80 38 St, #C8, Astoria, NY, 11105, US

(73) Assignee: DYNASCAN TECHNOLOGY CORP., Tao-Yuan Hsien (TW)

(21) Appl. No.: 12/546,637

(22) Filed: Aug. 24, 2009

(30) Foreign Application Priority Data
Dec. 23, 2008 (TW) 097150248

(51) Int. Cl. H04N 9/31

(52) U.S. Cl. 348/744; 348/E09.025

(57) ABSTRACT

The present invention relates to a rotary display provided with an image pickup device, comprising: a base; a rotary frame, light-emitting components, an image data supplying device and a image pickup device. The rotary frame on which the light-emitting components are mounted is adapted for rotating about an axis with respect to the base and formed with transparent portions having through holes, such that the image pickup device mounted on the base can capture an outside image through the transparent portions. The light-emitting components are actuated by the image data supplying device to emit light outwardly, whereby the light sources of the light-emitting components constitute images with high resolution by taking advantage of persistence of vision, while the image pickup device is hidden within an interior space of the rotary frame.

### FIELD OF THE INVENTION

The present invention relates to a rotary display, and more particularly, to a rotary display provided with an image pickup device.

### DESCRIPTION OF THE RELATED ART

Global economy recession and continuous deterioration of the law and order situation have led to a rash of burglaries and robberies. The installation of monitoring system for residential and office usage has been a necessity in line with the increasing number of robbery and break-in cases.

A conventional fixed-mount monitoring camcorder 60, as shown in FIG. 1, is often mounted under ceiling or other elevated spots in buildings, such that it takes images of passing pedestrians using a lens 641 to achieve the monitoring purpose. The lens 641 is normally set downward at a certain angle below the horizontal and has a field of view shown by dashed lines in the FIG. 1. Further efforts have been made to hide the camcorder behind a spherical shield made of transparent material, so as to protect the lens from contamination or damage caused by being hit with an external object. The conventional monitoring systems described above, however, are still too obvious and have blind spots, allowing a potential criminal to circumvent and even to disable the monitoring systems.

Moreover, as the lens 641 of the camcorder 60 is set downward at a certain angle below the horizontal, the crucial facial features of an interested object are oftentimes captured as deformed images with a large forehead and small jaws and consequently result in an increased complexity in identifying a target personnel. The problem of inferior capturing of facial features using the lens 641 would become more serious if the target personnel wears a cap to disguise himself.

Therefore, there exists a need for a monitoring system that attracts public attention while making an image pickup device disguised. The monitoring system cannot only be mounted under ceiling or other elevated spots in buildings but also can be installed at a height equivalent to the average human height or at any other heights according to the operator's demands, such that the captured images are closely resemble to the front view of a human object looking straight forward. By virtue of the technical features described below, the invention significantly reduces the interference caused by a cap visor or an umbrella and further effectively overcomes the problem of facial image deformation caused by an improper angle for capturing images.

### SUMMARY OF THE INVENTION

Accordingly, an object of the present invention is to provide a monitoring system by incorporating an image pickup device into a conventional rotary display, wherein the image pickup device is fully hidden by the light emitted from the light sources mounted on the display during the rotation of the rotary display.

Another object of the invention is to provide an rotary display that attracts people to linger around while capturing images of the front views of people using an image pickup device.

It is still another object of the invention to provide a rotary display adapted for capturing images at a height required by the installer to prevent image deformation caused by an improper angle for capturing images.

It is still another object of the invention to provide a rotary display, which allows analysis for consumers' attitudes toward the goods displayed in the commercials by examining the images captured by an image pickup device.

The present invention therefore provides a rotary display provided with an image pickup device, comprising: a base; a rotary frame adapted for rotating about an axis with respect to the base, wherein the rotary frame has an inner surface and an outer surface and is formed with a plurality of transparent portions that extend through the inner and outer surfaces; and an image pickup device mounted on the base and positioned in an interior space defined by the rotary frame, such that the image pickup device captures an image outside of the rotary frame through one of the transparent portions by registering with the transparent portion.

The invention further provides a rotary display provided with an image pickup device and having a base, a rotary frame, an image data supplying device and a plurality of light sources mounted on the rotary frame, the improvement of which comprises: the rotary display further comprising an image pickup device mounted on the base and positioned in an interior space defined by the rotary frame to capture an image outside of the rotary frame.

Since a rotary display is installed for the purpose of attracting public attention to the commercials or other image information displayed thereon, it is normally mounted at easy eye contact height with pedestrians, such that the position of the image pickup device disposed therein can be so close to the average human height as to eliminate the image deformation problem caused by an improper angle for capturing images. By hiding the image pickup device within an interior space, the rotary display according to the invention will not give stress to pedestrians but confusing a potential criminal as to where the image pickup device is pointing. In addition, since people's eyes are attracted to the displayed images, the images captured by the image pickup device correspond closely to a front view of people looking straight forward and, in view of this fact, the invention achieves security and control effects with high efficiency. In particular, when working in cooperation with the suitable hardware and software for image analysis, the invention facilitates evaluation for the advertising effects of the image data (such as commercials) displayed thereon.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 depicts the image capturing effect achieved by a conventional monitoring camcorder;

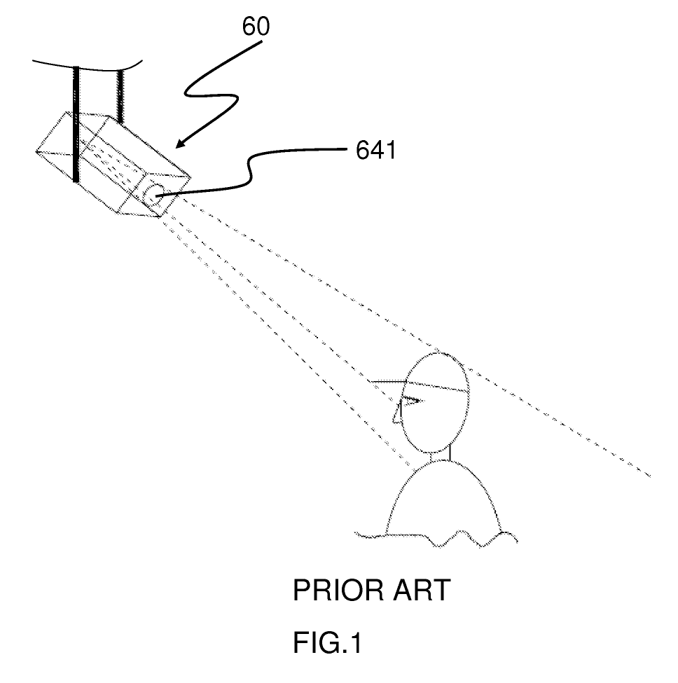

FIG. 2 is a schematic diagram comparing the image capturing effect of the first preferred embodiment of the invention with that of a conventional monitoring camcorder;

FIG. 3 is a side view diagram of the first preferred embodiment of the invention;

FIG. 4 is a perspective view of the embodiment shown in FIG. 3;

FIG. 5 is a schematic top view of the embodiment shown in FIG. 3, showing that the camcorders register with the transparent portions;

FIG. 6 is another schematic top view of the embodiment shown in FIG. 3, showing that the camcorders are blocked by the light-emitting components;

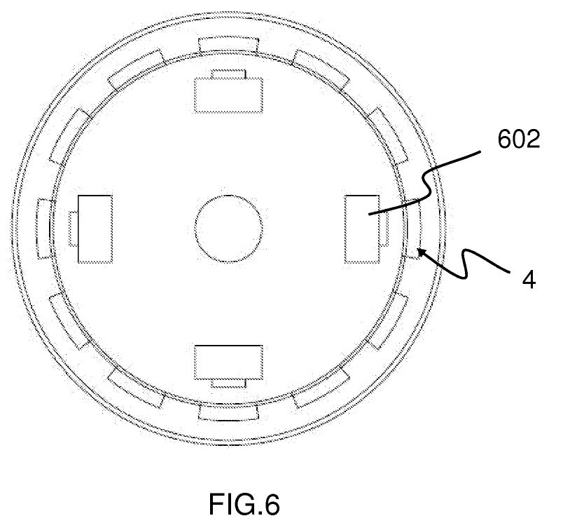

FIG. 7 is a side view diagram of the second preferred embodiment of the invention;

FIG. 8 is a flow chart showing the data manipulating procedure according to the invention; and

FIG. 9 is a rotary display attached with stickers only.

### DETAILED DESCRIPTION OF THE INVENTION

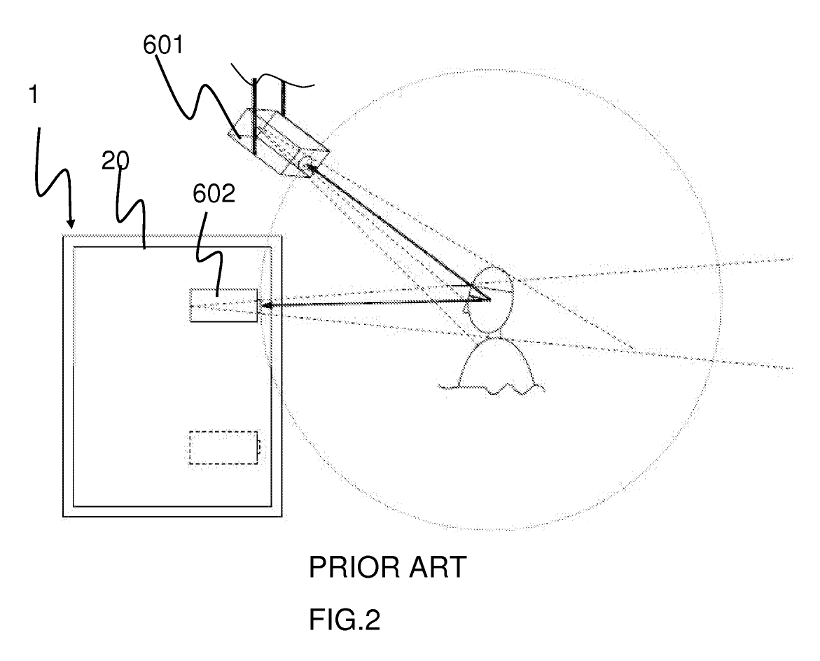

For illustrative purpose, the first preferred embodiment of the invention is shown in FIG. 2 in comparison with a conventional safety monitoring and controlling equipment in the form of a camcorder 601. The ceiling-mounted camcorder 601 when taking images from above would possibly have a field of view blocked by the visor of a cap worn on a human object's head as shown by dashed lines in the Figure. As a consequence, the camcorder 601 can only capture an image from the nose to the chest of the object with the major facial features, including eyes and eyebrows, being hardly recognized. In contrast, another identical camcorder 602 in combination with a rotary display 1 are disposed in front of and horizontal to the human object at similar distance conditions, so that the image thus captured is closely resemble to the front view of the human object looking straight forward, thereby significantly reducing the interference caused by a cap visor or an umbrella. Therefore, the invention can effectively pick up the features of the interested object and further deal with the problem of deformed facial images which normally occur when the images are taken downward.

In addition, an image displaying portion of the rotary display 1 may exhibit commercials to draw public attention and attract people to come close. Meanwhile the camcorder 602 hidden inside of a rotary frame 20 performs monitoring by taking people's images. Further, the images captured by the camcorder 602 during a certain time interval may be compared with the commercials displayed in the same interval to analyze consumers' attitudes toward goods.

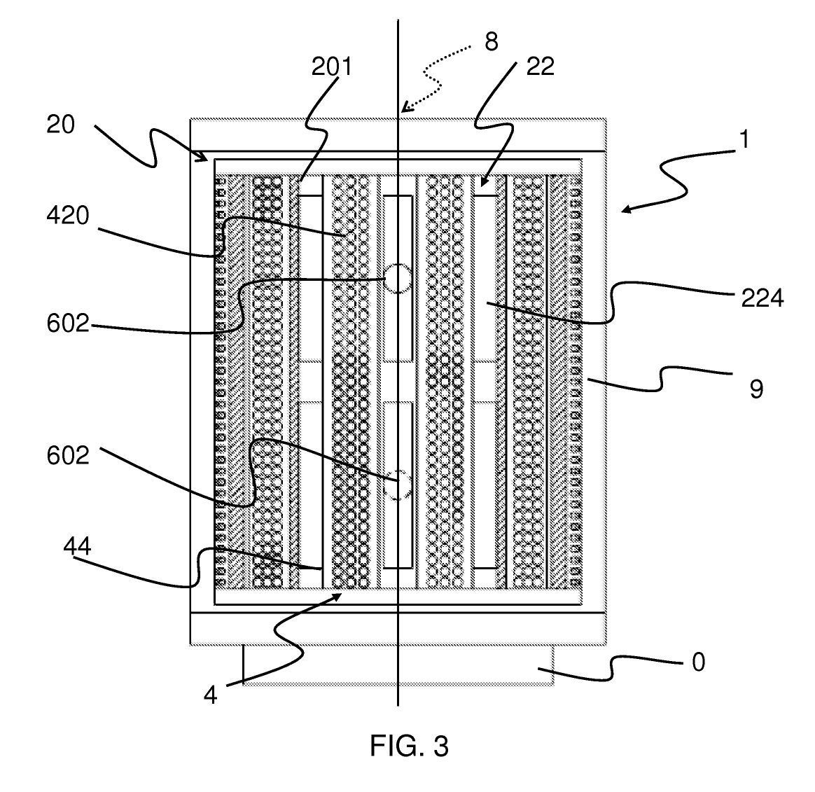

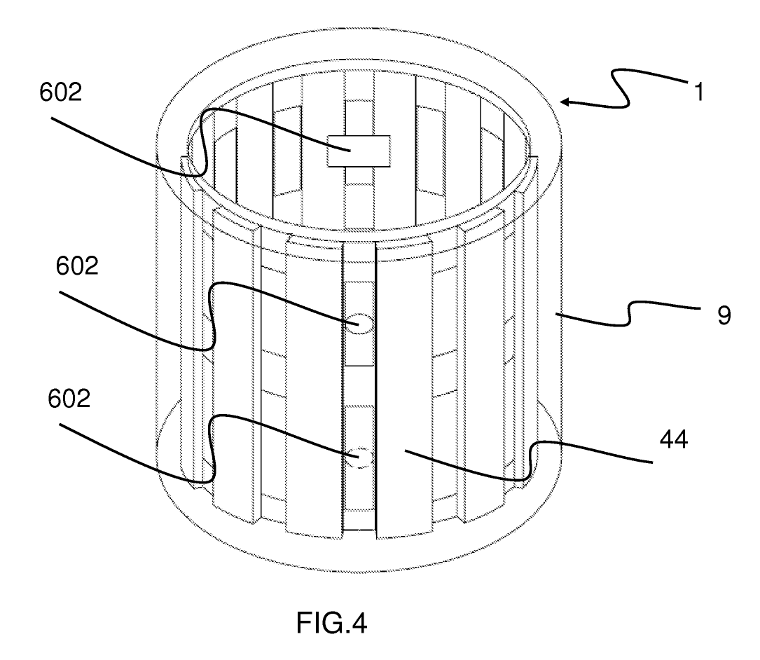

As shown in FIGS. 3 and 4, the rotary display 1 provided with an image pickup device according to the first preferred embodiment of the invention comprises a base 0, a rotary frame 20, an image data supplying device for outputting image data, a plurality of light-emitting components 4, an image pickup device and a transparent shield 9.

In this embodiment, the rotary frame 20 may by way of example be a vertically erected cylindrical frame driven by an external motor to rotate about an imaginary axis 8 with respect to a base 0. In this embodiment, a plurality of transparent portions 22 are so configured as to define between two strips of light-emitting components 4 a plurality of through holes that extend through the rotary support 201. The rotary support 201 further includes a transparent plate 224 for concealing the through holes from outside. The light-emitting components 4 may by way of example be matrix arrays of light emitting diodes (LEDs) 420 that function as the light sources. For example, LED arrays that emit red, blue and green lights, respectively, are alternately arranged on the substrates 44 of the image displaying portion and adapted to be rotated in association with the rotation of the rotary frame 20. The image displaying portion corresponds to the outer portion of rotary frame 20 exclusive of the transparent portions 22. The rotary frame 20 is additionally covered by a cylindrically shaped transparent shield 9 made of transparent material such as glass or acrylate polymers, in order to protect the rotary frame 20 from damage caused by being hit with an external object.

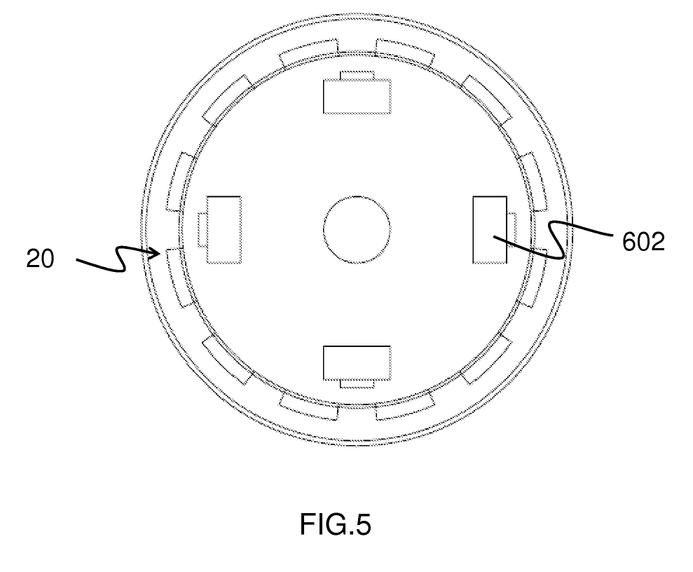

The image pickup device includes at least one camcorder which may be replaced with a camera. The number of the camcorders/cameras used may vary depending upon the actual need. As shown in the top view of FIG. 5, eight camcorders 602 are mounted in two layers on the base 0, by four camcorders 602 in every layer. With the camcorders 602 being securely mounted onto the base 0 and positioned in an interior space defined by the rotary frame 20, the camcorders 602 are allowed to capture images outside of the rotary frame 20 by registering with the transparent portions 22 when the rotary frame rotates to the position shown in FIG. 5. On the contrary, when the front side of the camcorders 602 are blocked by the light-emitting components 4, the camcorders 602 are turned off and kept idle temporarily.

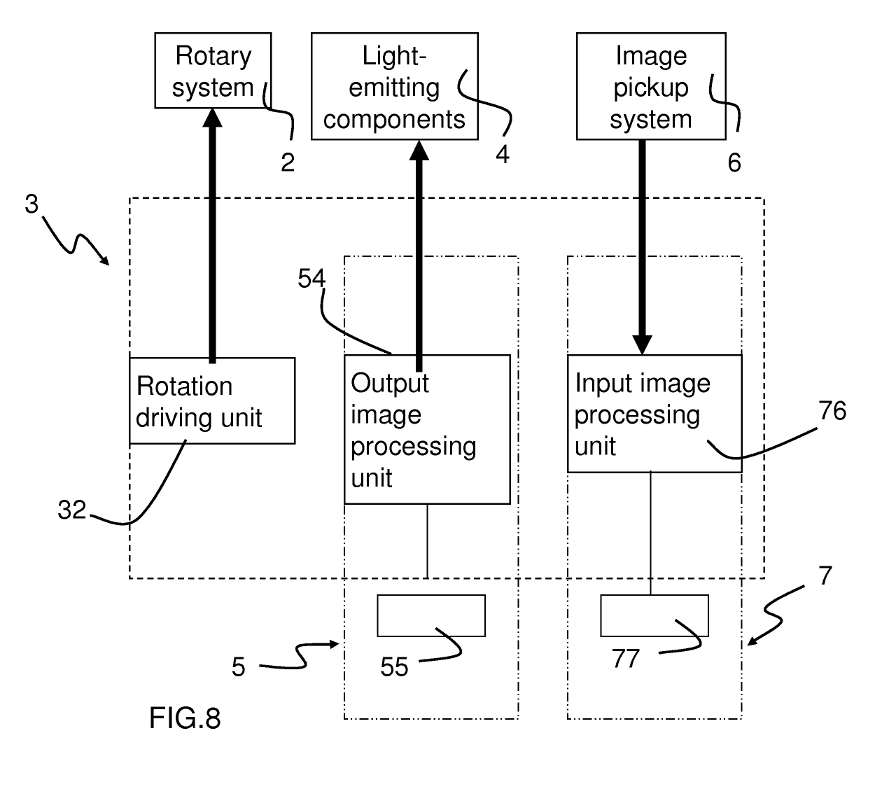

As illustrated in FIG. 8, the rotary display according to the invention may be provided with an image transmission system comprising an image data supplying device 5 for outputting image data. The image data supplying device 5 may include an output image processing unit 54, and a storage device for image data which may by way of example be a memory device 55 according to this embodiment. A central processor 3 is provided to synchronize the running speed of the video document to be displayed with the rotation speed of the rotary system 2. The output image processing unit 54 gains access to the memory device 55 to acquire the video document in the Flash format, for example, and then transmits image signals to the light-emitting components 4, thereby enabling the light sources to emit light outwardly from the rotary frame. Images are created by taking advantage of persistence of vision in combination with rotating the rotary frame at high speed.

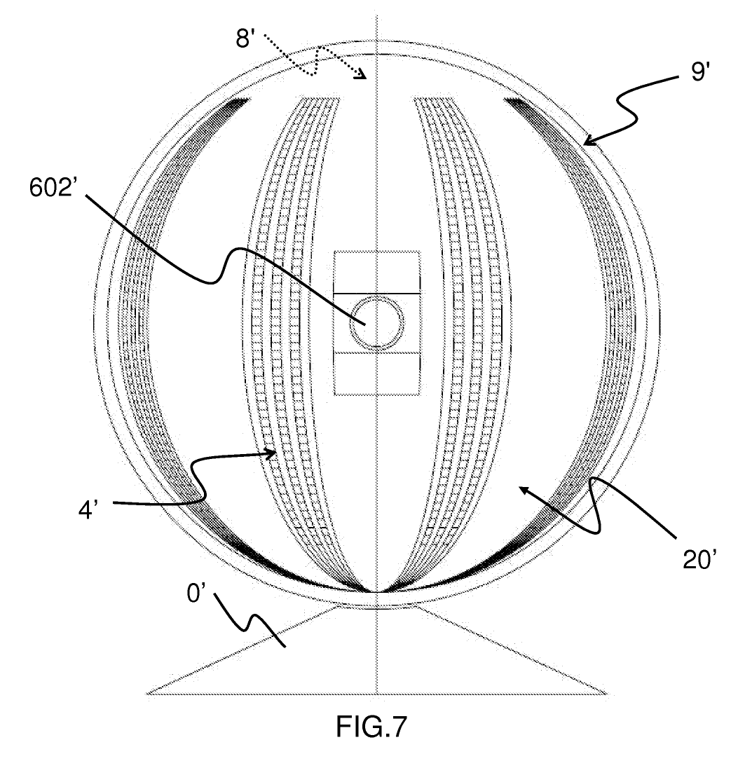

Of course, it would be appreciated by those skilled in the art that the specific configuration of the rotary display provided with an image pickup device, as well as the constituting components thereof, as described in the embodiment above are provided for illustrative purpose only and are not intended to limit the scope of the invention. As shown in FIG. 7, a rotary display according to the second preferred embodiment of the invention similarly comprises a base 0′, an image data supplying device for outputting image data and a plurality of light-emitting components 4′ and is configured to be rotable about an imaginary axis 8′ with respect to the base 0′. The rotary display shown in FIG. 7, however, is equipped with a single camcorder 602′, while the rotary frame 20′ that resides in the interior space defined by the transparent shield 9′ is made in the form of a spherical frame to which the light-emitting components 4′ are firmly attached in an arc shape.

FIG. 8 is a flow chart showing the data manipulating procedure performed in the rotary display according to the invention. The largest square surrounded by dashed lines in the Figure represents a central processor 3, which drives a rotation driving unit 32, an output image processing unit 54 and an input image processing unit 76 to operate in a cooperative manner. The rotation driving unit 32 transmits a rotation signal to the rotary system 2 and the rotary system 2, such as the rotary frame described above, starts to rotate responsive to receipt of the signal. The image data supplying device 5 for outputting image data works in cooperation with the central processor 3, such that the output image processing unit 54 reads an image document stored in the memory device 55, converts the same into image signals and then transmits the image signals to the light-emitting components 4, thereby enabling the light sources to emit the desired color of light outwardly. The image data processing device 7 includes an input image processing unit 76 and a storage device 77 such as a video tape. Images captured by the image pickup system 6 are converted by the input image processing unit 76 and transmitted to and stored in the storage device 77. In addition to being used for the monitoring purpose, the captured images are applicable in sampling analyses and market survey for useful information including the total number of pedestrians passing through the point where the rotary display is placed within a certain time interval, as well as the ratio of male to female pedestrians, the ratio of juvenile to adult pedestrians and so on.

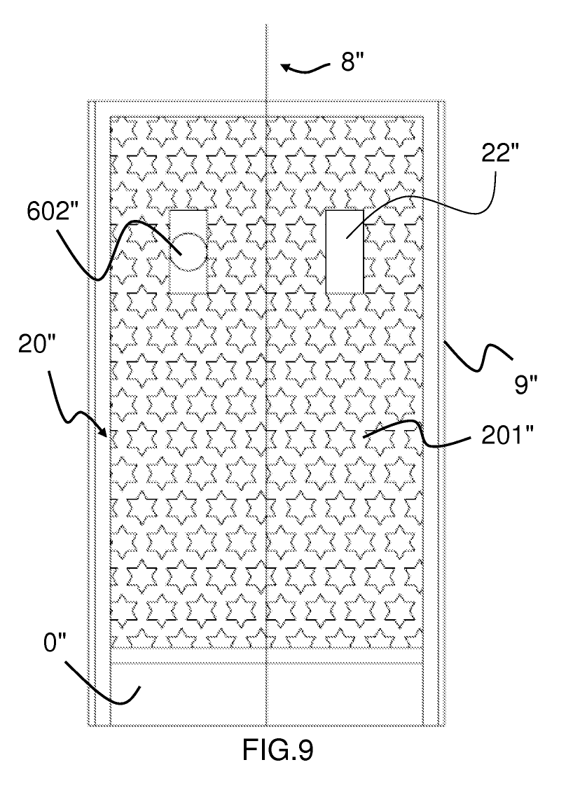

The use of invention is certainly not limited to displaying commercial images formed by the light sources but includes serving as a bulletin board system for displaying posters, authentic works and so on. The rotary frame can even be so printed directly with pictures or words as to constitute an image displaying portion. As shown in FIG. 9, a rotary support 201″ is fully attached with hexagram-shaped stickers and only the portions that register with the field of view of a camera 602″ or correspond to a transparent portion 22″ are spared and removed. The rotary frame 20″, like those described in the embodiment above, is mounted within a transparent protective shield 9″ and adapted to rotate about an imaginary axis 8″ with respect to a base 0″ disposed beneath.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A rotary display provided with an image pickup device, comprising:
a base;
a rotary frame adapted for rotating about an axis with respect to the base, wherein the rotary frame has an inner surface and an outer surface and is formed with a plurality of transparent portions that extend through the inner and outer surfaces; and
an image pickup device mounted on the base and positioned in an interior space defined by the rotary frame, such that the image pickup device captures an image outside of the rotary frame through one of the transparent portions by registering with the transparent portion.

2. The rotary display according to claim 1, further comprising:
an image data supplying device for outputting image data; and
a plurality of light sources mounted on the rotary frame and adapted for being actuated by the image data supplying device to emit light outwardly from the rotary frame, whereby the light sources constitute an image corresponding to the output image data during the rotation of the rotary frame.

3. The rotary display according to claim 2, wherein the light sources are light emitting diodes arranged in matrix arrays.

4. The rotary display according to claim 1, further comprising an image displaying portion mounted on the outer surface of the rotary frame.

5. The rotary display according to claim 1, wherein the rotary frame is a vertically erected cylindrical frame.

6. The rotary display according to claim 1, wherein the rotary frame is a spherical frame.

7. The rotary display according to claim 1, wherein the rotary frame comprises:
a rotary support formed with a plurality of through holes in the transparent portions; and
a plurality of transparent plates mounted on the rotary support for concealing the through holes from outside.

8. The rotary display according to claim 1, wherein the image pickup device comprises at least one camcorder.

9. The rotary display according to claim 8, further comprising an image data processing device for receiving and processing an image data captured by the at least one camcorder.

10. In a rotary display having a base, a rotary frame, an image data supplying device and a plurality of light sources mounted on the rotary frame, the improvement comprising: the rotary display further comprising an image pickup device mounted on the base and positioned in an interior space defined by the rotary frame to capture an image outside of the rotary frame.
